(19) United States
(12) Patent Application Publication
(10) Pub. No.: US 2026/0075260 A1
(43) Pub. Date: Mar. 12, 2026

(54) DECODING METHOD, ENCODING METHOD, DECODING DEVICE, ENCODING DEVICE AND DISPLAY DEVICE FOR DISPLAYING AN IMAGE ON A TRANSPARENT SCREEN

(71) Applicant: BEIJING XIAOMI MOBILE SOFTWARE CO., LTD., Beijing (CN)

(72) Inventor: Emmanuel THOMAS, Beijing (CN)

(73) Assignee: BEIJING XIAOMI MOBILE SOFTWARE CO., LTD., Beijing (CN)

(21) Appl. No.: 18/704,021

(22) PCT Filed: Oct. 25, 2021
(86) PCT No.: PCT/CN2021/126180

§ 371 Date: Apr. 23, 2024

(51) Int. Cl. H04N 19/93; H04N 19/172; H04N 19/70

(52) U.S. Cl. CPC H04N 19/93; H04N 19/172; H04N 19/70

(57) ABSTRACT

Apparatus and method are provided for decoding an encoded video bitstream with multiple frames for displaying a video on a transparent display. The method includes: receiving the encoded video bitstream, in which the video bitstream includes image data including multiple image values representing an image to be displayed and transparency data representing an intended transparency level of at least a part of the image to be displayed. For at least one frame of the video bitstream: the method further includes decoding received encoded image data to obtain a decoded image data; determining whether a current frame includes transparency data; in case the current frame includes transparency data: adjusting the decoded image data to obtain a transparency-adjusted image data depending on received transparency data.

### CROSS-REFERENCE TO RELATED APPLICATION

The present application is a U.S. national phase application of International Application No. PCT/CN2021/126180, filed on Oct. 25, 2021, the disclosure of which is incorporated herein by reference in its entirety for all purposes.

### TECHNICAL FIELD

The disclosure relates to a method for decoding an encoded video bitstream for displaying an image on a transparent screen and a corresponding encoding method. The disclosure further relates to a decoding device, an encoding device, a display device, a video bitstream and a non-transitory computer-readable storage medium.

### BACKGROUND

According to the related art, a video bitstream has to be provided that is adapted to the specific display technology of a display device regarding the transparency effect. For instance, if a video bitstream is to be stored on a storage medium such as a DVD, or transmitted to a client over a network, different video bitstreams need to be provided on the DVD or stored and transmitted over the network in order to support the different TVs.

### SUMMARY

According to an aspect of the disclosure, a method for decoding an encoded video bitstream with multiple frames for displaying a video on a transparent display is provided, wherein the method comprises: receiving the encoded video bitstream, wherein the video bitstream comprises image data comprising multiple image values representing an image to be displayed and transparency data representing an intended transparency level of at least a part of the image to be displayed; for each frame of the video bitstream: decoding received encoded image data to obtain a decoded image data; determining whether a current frame is associated with the transparency data; in case the current frame is associated with the transparency data: adjusting the decoded image data to obtain a transparency-adjusted image data depending on received transparency data.

According to a further aspect of the disclosure, a method for displaying a video on a transparent display is provided, wherein the method comprises: decoding an encoded video bitstream with multiple frames according to the method as described above; and displaying an image according to the transparency-adjusted decoded image data in case the current frame is associated with transparency data and displaying an image corresponding to the decoded image data in response to the current frame not being associated with transparency data.

According to a further aspect of the disclosure, a method for generating an encoded video bitstream with multiple frames for displaying a video on a transparent display is provided, wherein the method comprises: receiving a video sequence, wherein the video sequence comprises image data comprising multiple image values representing an image to be displayed; for each frame of the video sequence: encoding the image data of a current frame; providing transparency data representing an intended transparency level of at least a region of the image to be displayed, in case the current frame is intended to represent a transparent image; writing the encoded frame into an output video bitstream.

According to a further aspect of the disclosure, a decoding device comprising a processor for decoding the encoded video bitstream comprising multiple frames is provided, wherein the decoding device is configured to receive the encoded video bitstream, wherein the video bitstream comprises image data comprising multiple image values representing an image to be displayed and transparency data representing an intended transparency level of at least a region of the image to be displayed; and wherein the processor is, for each frame of the video bitstream, configured to: decode received image data to obtain a decoded image data; determine whether a current frame is associated with the transparency data; in case the current frame is associated with the transparency data: adjust the decoded image data to obtain a transparency-adjusted image data depending on received transparency data.

According to a further aspect of the disclosure, a display device for displaying a transparent image is provided, wherein the display device comprises: a decoding device as described above; a transparent screen, wherein the decoding device is configured to output the transparency-adjusted image data to the transparent screen.

According to a further aspect of the disclosure, an encoding device comprising a processor for encoding a received video sequence is provided, wherein the encoding device is configured to receive the video sequence, wherein the video sequence comprises image data with multiple image values representing an image to be displayed; and the processor is, for each frame of the video sequence, configured to: encode the image data of a current frame; provide transparency data representing an intended transparency level of at least a region of the image to be displayed; write the encoded frame into an output video bitstream.

According to a further aspect of the disclosure, a video bitstream with multiple frames for displaying a video on a transparent display is provided, wherein the bitstream comprises image data comprising multiple image values representing an image to be displayed and transparency data representing an intended transparency level of at least a region of the image to be displayed, wherein the video bitstream is generated by the method as described above.

### BRIEF DESCRIPTION OF THE DRAWINGS

Reference will now be made to the enclosed drawings, wherein the drawings show the following:

FIG. 1 illustrates the basic principle of an LCD,

FIG. 2 illustrates an embodiment of the decoding method according to the disclosure,

FIG. 3 illustrates an embodiment of the encoding method according to the disclosure,

FIG. 4 illustrates an embodiment of the encoding device according to the disclosure,

FIG. 5 illustrates an embodiment of the decoding device according to the disclosure,

FIG. 6 illustrates an embodiment of the video bitstream according to the disclosure, and

FIG. 7 illustrates an embodiment of the transparency data according to the disclosure.

### REFERENCE SIGNS

11 first polarizing filter
12 first electrode
13 liquid crystal
14 second electrode
15 second polarizing filter
16 reflective surface
110 first step of an embodiment of the decoding method
120 second step of an embodiment of the decoding method
130 third step of an embodiment of the decoding method
140 fourth step of an embodiment of the decoding method
210 first step of an embodiment of the encoding method
220 second step of an embodiment of the encoding method
230 third step of an embodiment of the encoding method
240 fourth step of an embodiment of the encoding method
300 decoding device
310 storage element of the decoding device
320 processor unit of the decoding device
400 encoding device
410 storage element of the encoding device
420 processor unit of the encoding device
500 video bitstream
510 header parameters
520 image data
530 transparency data

### DETAILED DESCRIPTION OF THE EMBODIMENTS

According to the related art, a video bitstream has to be provided that is adapted to the specific display technology of a display device regarding the transparency effect. For instance, if a video bitstream is to be stored on a storage medium such as a DVD, or transmitted to a client over a network, different video bitstreams need to be provided on the DVD or stored and transmitted over the network in order to support the different TVs.

From the content creator perspective, there are multiple types of screens to support when making content, namely conventional (opaque) screens, LCD transparent screen and OLED transparent screen. Creating a video content for those three categories means to produce three different video contents, one for conventional displays, one for transparent displays with clear pixels as white pixels (e.g. LCD) and one for transparent display with clear pixels as black pixels (e.g. OLED). This causes higher production cost, storage cost and computational cost for encoding the video.

Consequently, the storage and transmission of this source content in three different variations will also cause:
higher storage costs in the distribution chain (e.g. in Content Delivery Network (CDN) where the content is duplicated in three variants)

higher network usage since the content, being different, cannot be cached between conventional and transparent screens.

In order to allow a comprehensive understanding of the disclosure, a short description of LCD Error! Reference source not found. and OLED Error! Reference source not found. technologies shall be discussed first. In particular, details that matter for the purpose of the disclosure will be discussed in more detail. There exist several types of displays but only these two are of interest in the context of the present disclosure since LCDs and OLEDs are also used to make transparent displays (also referred to as see-through displays). If in the future, new types of transparent displays emerge beyond LCDs and OLEDs, the disclosure would be equally applicable to those new types.

### LCD:

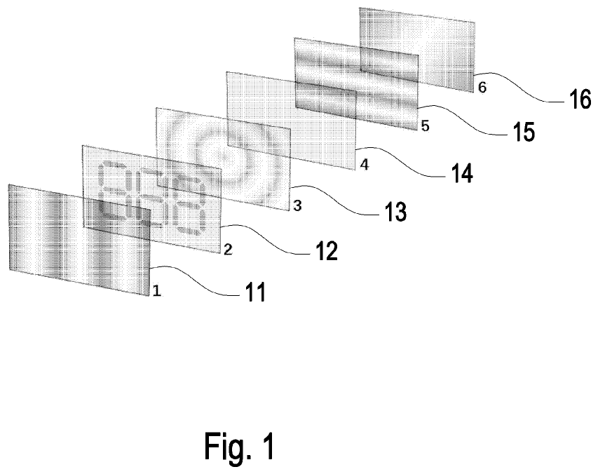

Each pixel of an LCD typically consists of a layer of molecules aligned between two transparent electrodes, often made of Indium-Tin oxide (ITO) and two polarizing filters (parallel and perpendicular polarizers), the axes of transmission of which are (in most of the cases) perpendicular to each other (see citation [1]). Without the liquid crystal between the polarizing filters, light passing through the first filter would be blocked by the second (crossed) polarizer. Before an electric field is applied, the orientation of the liquid-crystal molecules is determined by the alignment at the surfaces of electrodes. In a twisted nematic (TN) device, the surface alignment directions at the two electrodes are perpendicular to each other, and so the molecules arrange themselves in a helical structure, or twist. This induces the rotation of the polarization of the incident light, and the device appears gray. If the applied voltage is large enough, the liquid crystal molecules in the center of the layer are almost completely untwisted and the polarization of the incident light is not rotated as it passes through the liquid crystal layer. This light will then be mainly polarized perpendicular to the second filter, and thus be blocked and the pixel will appear black. By controlling the voltage applied across the liquid crystal layer in each pixel, light can be allowed to pass through in varying amounts thus constituting different levels of gray. Most color LCD systems use the same technique, with color filters used to generate red, green, and blue subpixels. In FIG. 1, the basic principle of an LCD is illustrated.

As mentions above, the LCD principle has evolved to offer colour representation with added colour filters and better brightness with a backlight.

The key points which are relevant for the domain of transparent screens are:
LCD displays do not produce light which means that the light needs to come from somewhere. For TV screens, sources of light are placed in the TV sets to illuminate the cells.
LCD displays make black pixels by fully stopping the light coming from the back layer (reflective or emissive).
LCD displays make white pixels by letting the light coming from behind passing through all the components of the colour filter.

OLED:

An organic light-emitting diode (OLED or organic LED), also known as organic electroluminescent (organic EL) diode (see citation [1], [2]) is a light-emitting diode (LED) in which the emissive electroluminescent layer is a film of organic compound that emits light in response to an electric current (see citation [8]). This organic layer is situated between two electrodes; typically, at least one of these electrodes is transparent. An OLED display works without a backlight because it emits visible light by itself.

The key points which are relevant for the domain of transparent screens are:
each organic LED produces its own light.
OLED displays make black pixels by turning off the organic LEDS at the position of the black pixel.

### Transparent Displays:

Transparent displays (also referred to as see-through displays) Error! Reference source not found. generally refer to display technologies which allow the viewer to see both the content being displayed on the screen as well as the physical objects behind the screen. It is thus a characteristic of those screens to be able to display an image while letting the light coming from behind the screen to traverse the screen and hit the viewer's eye.

Historically, the first versions of transparent displays were using LCD display technology in the 2010s. However, LCD transparent screens merely filter the incoming light from behind the TV to illuminate the pixels which effectively means that those screens could not work in a dark room. This is one of the reasons why OLED-based transparent displays quickly became a more promising approach since OLED screens comprise self-emitting pixels. That is, each pixel of an OLED screen contains its source of light. In a nutshell, an OLED-based transparent display is made of a regular OLED screen in which the manufacturer has punched a very large number of holes so that the light can traverse the screen from behind. Note that since the OLED screen emits light only in one direction, a viewer behind the screen would not be able to see the displayed content on the screen.

In terms of applications, those type of screens can equip glasses so that the user is able to see the world around and at the same receive added information. Those applications fall in the Augmented Reality category (see citation [10]). Transparent displays can also be built into TV sets in which case they are usually called transparent screens or transparent TV. The first type of applications for those screens was for advertisement purposes in shops, trade shows, etc.

More recently, TV manufacturers started shipping TV models to the mass market where the screen is a transparent screen. Examples are LG, Panasonic and Xiaomi Mi Lux 55′.

AR/Smart glasses:

Another type of see-through display falls in the category of head-mounted displays. Examples of smart glasses are the Google Glass or the Xiaomi Smart Glasses. On those devices, the information on screen is overlaid on top of what the user sees but the overlaid information is not spatially aligned with the world around the user. As opposed to AR glasses which track the user's surrounding and display content on the glasses in such way that it augments the world the user sees. Examples of AR glasses are Microsoft HoloLens or Magic Leap.

### Transparency Control in Transparent Screens:

For both LCD and OLED-based transparent screens, the fact that the viewer is able to perceive the scene or parts of the scene behind the TV is determined by the value of the pixels. There are two extreme cases. The first one is when the user doesn't see at all what is behind the screen, i.e. total opacity. The second one is when the user fully sees what is behind the TV and no other image displayed on the TV, i.e. total transparency. In between those cases, there is a continuous spectrum of transparency level wherein the user sees the displayed image on the screen overlayed on top of the scene behind the TV. All those cases, full opacity, full transparency and intermediate transparency can be for the entire screen or localised up to a granularity of a pixel for the best see-through display technology such as current OLED displays.

Depending on LCD or OLED technologies, each of the effects described above, i.e. full opacity, full transparency and intermediate transparency, is realised in a different manner. For LCDs, a pixel is black when as much light as possible coming from the light source is stopped. As a result, a dark pixel will not let the light traverse from behind the TV and will appear opaque for the viewer. Conversely, a pixel is white when all the light comes through all the sub colour pixels to form a white light beam. As a result, the light from behind may also traverse the pixel through the holes and thus the objects behind may be visible to the viewer, hence creating the transparency effect.

| Effect | Transparent LCD | Transparent OLED |
|---|---|---|
| Opaque pixel | Black pixel | White pixel |
| Transparent pixel | White pixel | Black pixel |

On a transparent OLED, the black pixels (light turned off) let the light coming from behind passing through the screen. This effectively means that in this simple version of transparent OLED screen, it is not possible to display black on the screen.

Conversely, it is not possible to display white pixels on transparent LCD screens provided the scene on the back of the TV is not white. As a consequence, objects behind the LCD screen are typically barely visible in the black area of the display but appear clearly visible in the white area of the screen.

There are OLED TV models wherein an additional layer is placed right behind the screen. This additional layer is responsible for dimming the light coming from behind. The purpose of this dimming layer is to improve OLED-based transparent screens in such a way that dark pixels can also be made opaque by activating this layer. Another use of this layer is to switch between a conventional opaque TV to a transparent TV mode. There can be indeed cases where the content is not made for transparent screens and leads to a bad user experience in which case it is advantageous for the user to be able to switch to a conventional opaque TV mode. As of today, it appears that it is possible to activate this dimming layer at different levels of dimming intensity but only for the whole screen at once. That is, the dimming layers known so far are not able to be localised to some regions/pixels of the screen.

In addition to the differences between OLEDs and LCDs regarding the transformation of transparency levels to pixel values, the transparency effect perceived by the user is also determined by the ambient lighting around the TV. For example, if an OLED transparent TV operates in a dark room, the objects behind the TV will barely appear compared to the same TV with the same pixel values on screen when the scene behind the TV is better lit. In the latter case, the user will perceive a better transparency effect while the values of the pixels on screen are strictly identical.

For all of these reasons, conveying the content creator's intent regarding the perceived transparency effect can be challenging due to different display technologies and unpredictable ambient viewing conditions.

The key idea of the disclosure is to signal a transparency mask (metadata) along with the transmitted conventional coded video stream to the receiver. This transparency mask expresses how to adjust the associated content for a transparent display, and optionally under certain ambient lighting conditions (provided the information is measured at the receiver). In this way
the content creator's intent is genuinely reproduced at the receiving side and the user experience is thus improved.
if the device is connected to a transparent screen, the decoder can modify the value of the samples in the decoded video sequence in such a way that the transparency on the transparent screen corresponds to the content creator's intent. Depending on the transparent screen technology, the final adjusted value of the samples may differ, e.g. white pixels for LCD and black pixels for OLED.
if the device is not connected to a transparent screen, or the user wishes to watch the content in a conventional fashion, provided the screens allows it (see above description relating to the dimming layer), then the decoder outputs the decoded video sequence in a conventional way and does not post process the samples after decoding by use of the transparency mask.

In order to solve the above-described problems and to achieve the desired benefits, a method for decoding an encoded video bitstream with multiple frames for displaying a video on a transparent display is provided, wherein the method comprises the following steps:
receiving the encoded video bitstream, wherein the video bitstream comprises image data comprising multiple image values representing an image to be displayed and transparency data representing the intended transparency level of at least a part of the image to be displayed;
for each frame of the video bitstream:
decoding the received encoded image data to obtain a decoded image data;
determining whether the current frame is associated with transparency data;
in case the current frame is associated with transparency data: adjusting the decoded image data to obtain a transparency-adjusted image data depending on the received transparency data.

The method allows to provide only a single video bitstream that can be used on different receiving devices, independent on the type of the receiving device. For instance, the provided method allows to use the same video bitstream for a transparent LCD TV, a transparent LED TV and a head mounted display device, since the signals for controlling the display device are generated on the receiver side and adapted for it. Implementing the provided method, it is not necessary to provide different video bitstreams for each display device, hence significantly reducing the storage capacity required to store and the network capacity required to transmit video data that is capable to be represented on different display devices.

For determining whether the current frame is associated with transparency data, it can be determined whether the current frame explicitly comprises transparency data or whether the transparency data is associated to the current frame in an implicit manner. In case the encoded video bitstream indicates that transparency data is associated to the current frame, the decoded image data is adjusted depending on the received transparency data and a transformation function that might be device-specific. In this case, the transparency-adjusted image data is output. In case the current frame is not associated with transparency data, the decoded image data is output without any further adjustments and adaptations.

As mentioned above, the transparency data might be explicitly provided for a specific frame. Alternatively, the transparency data might not be provided explicitly for one or several frames, but in an implicit manner. In such case, the encoded video bitstream might comprise a repetition indicator indicating that if no explicit transparency data is provided for a frame, this shall be interpreted by the decoding device such that the intended transparency settings for the current frame are the same as for the previous frame. Hence, if no explicit transparency data is provided, the same transparency settings as used for the previous frame are also implemented for the current frame. Thus, a highly data-efficient transmission of the transparency data can be provided. Such an embodiment providing implicit transparency data is particularly efficient in scenarios in which the transparency data does not change for larger amounts consecutive frames.

In contrast to generating a predetermined signal being adapted to a specific display device, such as an LED TV, metadata representing the intended transparency properties of an image are provided and converted to appropriate display control signals on the receiving side. Hence, display control signals can be calculated depending on the specific display device and, optionally, on ambient lighting information.

In some embodiments, the image data and the transparency data might be of the same dimensions. For instance, the image data might comprise 1920×1080 image values, each representing a pixel information for an image to be displayed, while the transparency data also comprises 1920×1080 transparency values, each representing the transparency of a pixel. However, the dimensions of the image data and the transparency data might also be different, as will be discussed below.

In some embodiments, the transparency data may comprise binary values representing the intended transparency of at least a part of the image to be displayed. For instance, the binary values might encode that the left half of an image should be displayed in a transparent mode while the right half of an image should be displayed in an opaque mode.

In some embodiments, the transparency data may comprise integer values representing the intended transparency of at least a part of the image encoded in the image data, wherein the integer values comprise N bit of data, N corresponding to 8, 10, 12 or 16. Hence, the transparency degree of an image—or a part of the image—may be adjusted gradually. Hence, some parts of an image may be allocated to different transparency degrees.

In some embodiments, the transparency data may comprise region parameters representing a defined region within the image represented by the image data, wherein one or several transparency values are allocated to the defined region. The regions might, for instance, represent a coherent shape within the image, e.g. a circle, an ellipse or a rectangle. The mentioned shapes can be represented with very little information. For instance, a rectangle can be represented by a reference point and the dimensions of the rectangle. The reference point may be the center of the rectangle or one of its corner points. Accordingly, in order to describe a rectangle, it is sufficient to only identify its reference point, its width and its height. Similarly, a circle, an ellipse or a triangle can be defined with little information. Hence, in spite of providing transparency values for all pixels of the image to be displayed, a significantly reduced amount of information is required to encode the transparency properties of an image by providing region parameters.

In some embodiments, a predetermined set of shapes might be defined, and each shape might be defined by a width parameter, a height parameter, center position parameter and a shape type parameter. In this way, a highly efficient encoding of the transparency information can be achieved.

Further, one or several regions might be allocated the same or different transparency values. Also, the transparency data may define that all pixels within one or several regions are intended to be transparent and all pixels outside the defined regions are displayed in an opaque mode. Alternatively, the transparency data may define that all pixels within one or several regions are intended to be displayed in an opaque mode while all pixels outside the defined regions are intended to be displayed in a transparent mode. For instance, if a user interface (UI) shall be displayed comprising selectable rectangular icons, those icons might be displayed in an opaque mode, while the rest of the displayed image is (completely or in part) transparent. Hence, a compact representation of the transparency information is provided, resulting in an efficient encoding of the transparency data.

In more general terms, a first transparency value can be allocated to the values inside the defined shapes and a second transparency value can be allocated to the values outside the defined shapes.

The regions according to the described embodiments are smaller than the entire image.

Furthermore, the defined regions can be assigned to a single transparency value, to several predetermined transparency values or to a function describing the transparency properties of the defined region. For instance, a rectangular shape might be defined, and the corresponding transparency values may be defined by a linear function that represent a gradual decrease of the transparency of the rectangular region in a horizontal direction.

In addition, the regions may be represented by region parameters and may be defined by region function parameters that allow to define more complex shapes. For instance, a parabolic function and a linear function may be defined, wherein a transparency value or a transparency function may be allocated to the region enclosed by the parabolic graph and the linear graph described by the functions. Hence, complex shapes may be defined and controlled with only a little amount of data being required for controlling the specific region of a display device.

In some embodiments, the transparency data might comprise a repetition flag defining whether the transparency settings implemented with the previous frame should be applied with the current frame as well. In many practical implementations, the transparency information does not change over time as frequently as the image information. Referring to the example discussed above and regarding the UI to be displayed, it becomes clear that the transparency information might be unchanged during most of the time. Hence, the transparency data belonging to most of the frames might be provided with a repetition flag set to “1”, indicating that the transparency properties remain unchanged. Only once the transparency properties change, e.g. due to additional selectable icons that have been added to the UI, a full set of transparency data need to be provided again. Hence, it becomes evident that providing a repetition flag with the transparency data might significantly reduce the amount of data that needs to be transmitted between an encoding device and a decoding device.

Optionally, the transparency data may comprise a different number of transparency values when compared to the number of image values comprised in the image data, wherein the method may comprise the additional step of resampling the transparency data to match the dimensions of the image data.

In some embodiments, the transparency data may comprise a reduced number of transparency values when compared to the number of image values comprised in the image data and wherein the method comprises the additional step of upsampling the transparency data to match the dimensions of the image data. In some applications, it is not necessary to provide transparency information with the same high resolution when compared to the image data. Hence, transparency data with a reduced resolution might be provided. Hence, the transferred data might be significantly reduced. For instance, if the image data comprises 1920×1080 image values, each representing a pixel of the image to be displayed, the transparency data might comprise only 960×540 transparency values. Hence, the amount of data transmitted between an encoder and a decoder might be reduced by a factor of 4, while still providing sufficient quality on the transparent display screen. On the decoder side, the downsampled transparency data is upsampled to match the dimensions of the image data.

Also, the transparency data may comprise an increased number of transparency values when compared to the number of image values comprised in the image data, wherein the method comprises the additional step of downsampling the transparency data to match the dimensions of the image data.

In some embodiments, the video bitstream comprises Supplemental Enhancement Information (SEI). The provided SEI can assist the processes related to decoding the encoded image data or displaying the image on the transparent screen.

In some embodiments, the SEI comprises a payload type indicator that indicates whether transparency data is contained in the video bitstream, and the method comprises the further steps of:
determining whether the payload type indicator equals to a first predetermined value representing the presence of transparency data; and
adjusting the decoded image data depending on the transparency data, in case the payload type indicator equals to the first predetermined value.

The payload type indicator may be provided a single time for one entire video bitstream. In such a case, the decoding device might transparency-adjust the decoded image data if the payload type indicator equals to a specific value, e.g. if the payload type indicator equals to “134”. Alternatively, the payload type indicator might be provided in each frame. According to this implementation, the decoding device might determine for each frame whether a payload type indicator is present and whether the payload type indicator equals to a predetermined value for each frame.

In some embodiments, the SEI comprises a run-length encoding indicator that indicates whether the transparency data is run-length encoded, and the method comprises the further steps of:
determining whether the run-length encoded indicator equals to a second predetermined value representing that the transparency data is run-length encoded; and
decoding the run-length encoded transparency data using a run-length decoding method, in case the run-length encoding indicator equals to the second predetermined value.

Using run-length encoding (RLE), the amount of data transmitted between the encoder and the decoder may be significantly reduced. For instance, in spite of providing 16 times consecutively the transparency value “0”, it is possible to replace the sequence of 16 zeros by the number “16” followed by the value “0”. In this way, an efficient compression of the transparency data can be provided, and less data needs to be transmitted between the encoding device and the decoding device.

In some embodiments, other encoding methods might be implemented to encode the transparency data. In such implementations, a corresponding encoding indicator that indicates the encoding method used for encoding the transparency data may be provided in the SEI, and the method may comprise the further steps of:
determining whether the encoder indicator equals to a predetermined value representing that the transparency data is encoded with a specific encoding method; and
decoding the encoded transparency data using the determined decoding method, in case the encoder indicator equals to a predetermined value.

In some embodiments, a method for displaying a video on a transparent display comprising the steps of the above-described method and, in addition, displaying an image according to the transparency-adjusted decoded image data in case the current frame comprises transparency data and, if no transparency data is determined, displaying an image corresponding to the decoded image data.

In some embodiments, the video bitstream may further comprises dimming data comprising multiple dimming values representing the dimming level of a dimming layer. The dimming data may be encoded in the same manner as the transparency data. In particular, the dimming data might comprise a binary mask, an integer mask and/or region parameters representing a defined region within the image represented by the image data.

In some embodiments, the method might comprise the following steps:
measuring the ambient light intensity in the environment of the transparent display; and
adjusting the decoded image data to obtain a transparency-adjusted image data depending on the measured ambient light intensity.

In this way, the transparency level of the image displayed on the transparent display can be adapted to the current ambient light conditions in the environment of the display, e.g. in a living room. For instance, if an ambient light sensor determines that the environment is rather dark, the transparency level of the image displayed on the transparent screen might be increased. To the contrary, if the ambient light sensor determines that the environment is rather well illuminated, the transparency level of the screen might be decreased. Thus, an optimum user experience is enabled independently from the current ambient light conditions.

Further, adjusting the decoded image data to obtain a transparency-adjusted image data depending on the measured ambient light intensity might be performed gradually. Hence, the precise value of the measured ambient light intensity may be considered for adjusting the decoded image.

According to a further aspect of the disclosure, a method for generating an encoded video bitstream with multiple frames for displaying a video on a transparent display is provided, wherein the method comprises the following steps:
receiving a video sequence, wherein the video sequence comprises image data comprising multiple image values representing an image to be displayed;
for each frame of the video sequence:
   encoding the image data of the current frame;
   providing transparency data representing the intended transparency level of at least a region of the image to be displayed, in case the current frame is intended to represent a transparent image;
   writing the encoded frame into an output video bitstream.

The described method can be implemented on an encoder providing an encoded video bitstream. Providing transparency data representing the intended transparency level of the image to be displayed allows to provide a single video bitstream for different display devices, such as transparent LCDs and transparent LEDs. The output bitstream may be stored on a storage device or transmitted directed to receiving devices.

In some embodiments, the transparency data may comprise binary values representing the intended transparency of at least a part of the image to be displayed.

In some embodiments, the transparency data comprises integer values representing the intended transparency of at least a part of the image encoded in the image data, wherein the integer values comprise N bit of data, N corresponding to 8, 10, 12 or 16.

Optionally, the transparency data may comprise region parameters representing a defined region within the image represented by the image data, wherein one or several transparency values are allocated to the defined region.

The region parameters might be designed in the same manner as described above in view of the decoding method. Hence, the amount of required data for encoding the transparency data might be significantly decreased.

In some embodiments, the transparency data comprises a reduced number of transparency values when compared to the number of image values comprised in the image data.

Also, the transparency data may be determined by downsampling transparency data comprising the same dimensions as the image data. Hence, the encoded video bitstream can be further compressed.

Optionally, the encoding method further comprises the step of providing Supplemental Enhancement Information (SEI) to the output video bitstream.

In some embodiments, the SEI may be provided with a payload type indicator that indicates whether transparency data is contained in the video bitstream, wherein the payload type indicator is set to a first predetermined value indicating that transparency data is available in the video bitstream.

Also, the encoding method may further comprise the step of run-length encoding the transparency data, wherein Supplemental Enhancement Information is provided to the output video bitstream comprising a run-length encoding indicator which indicates whether the transparency data is run-length encoded, wherein the run-length encoding indicator is set to a second predetermined value indicating the transparency data is run-length encoded.

According to a further aspect of the disclosure, a decoding device is provided comprising a processor for decoding an encoded video bitstream comprising multiple frames, wherein the decoding device is configured to:
receive the encoded video bitstream, wherein the video bitstream comprises image data comprising multiple image values representing an image to be displayed and transparency data representing the intended transparency level of at least a region of the image to be displayed;
wherein the processor is, for each frame of the video bitstream, configured to:
decode the received image data to obtain a decoded image data;
determine whether the current frame is associated with transparency data;
in case the current frame is associated with transparency data: adjust the decoded image data to obtain a transparency-adjusted image data depending on the received transparency data.

In some embodiments, the decoding device comprises a memory for storing, at least in part, an encoded video bitstream containing multiple frames for displaying a video on a transparent display.

In some embodiments, the transparency data may comprise a reduced number of transparency values when compared to the number of image values comprised in the image data and wherein the processor is further configured to upsample the transparency data to match the dimensions of the image data.

In some embodiments, the video bitstream comprises Supplemental Enhancement Information (SEI), comprising a payload type indicator that indicates whether transparency data is contained in the video bitstream, wherein the processor is configured to:
determine whether the payload type indicator equals to a first predetermined value representing the presence of transparency data; and
adjust the decoded image data depending on the transparency data, in case the payload type indicator equals to the first predetermined value.

In some embodiments, the video bitstream may comprise Supplemental Enhancement Information (SEI) comprising a run-length encoding indicator that indicates whether transparency data is run-length encoded, wherein the processor is configured to:
determine whether the run-length encoded indicator equals to a second predetermined value representing that the transparency data is run-length encoded; and
decode the run-length encoded transparency data using a run-length decoding method, in case the run-length encoding indicator equals to the second predetermined value.

According to a further aspect of the disclosure, a display device for displaying a transparent image is provided, wherein the display device comprises
a decoding device as described above;
a transparent screen.

In some embodiments, the display device might be implemented as a TV, a smart phone, a tablet or a head mounted display (HMD) device.

Also, the display device may comprise a dimming layer.

In some embodiments, the decoding device or the display device may comprise an ambient light sensor to measure the ambient light intensity in the environment of the decoding device and/or the display device. The additional ambient light sensor allows to determine the current ambient light intensity and to provide additional ambient light data describing the current ambient light conditions. Hence, providing an ambient light sensor allows to adjust the transparency level of the image to be displayed depending on the current ambient light conditions.

According to a further aspect of the disclosure, an encoding device is provided comprising a processor for encoding a received video sequence comprising multiple frames, wherein the encoding device is configured to:
receive the video sequence, wherein the video sequence comprises image data comprising multiple image values representing an image to be displayed;
and the processor is, for each frame of the video sequence, configured to:
encode the image data of the current frame;
provide transparency data representing the intended transparency level of at least a region of the image to be displayed;
write the encoded frame into an output video bitstream.

In some embodiments, the encoding device comprises a memory for storing, at least in part, a received video bitstream containing multiple frames.

In some embodiments, the processor is further configured to provide modified transparency data by downsampling transparency data comprising the same dimensions as the image data.

In some embodiments, the processor may be further configured to provide Supplemental Enhancement Information (SEI) to the output video bitstream, wherein the SEI comprises a payload type indicator that indicates whether transparency data is contained in the video bitstream, and the payload type indicator is set to a first predetermined value indicating that transparency data is available in the video bitstream.

Also, the processor may further be configured to run-length encode the transparency data and to provide Supplemental Enhancement Information to the output video bitstream comprising a run-length encoding indicator which indicates that the transparency data is run-length encoded, wherein the run-length encoding indicator is set to a second predetermined value indicating the transparency data is run-length encoded.

According to a further aspect of the disclosure, a video bitstream is provided with multiple frames for displaying a video on a transparent display, wherein the bitstream comprises image data comprising multiple image values representing an image to be displayed and transparency data representing the intended transparency level of at least a region of the image to be displayed, wherein the video bitstream is generated by the encoding method as described above.

In some embodiments, a non-transitory computer-readable storage medium storing processor-executed instructions which, when executed by a processor, cause the processor to perform the decoding method or the encoding method as described above.

Since the present disclosure relates to interrelated aspects such as a decoding method and an encoding method, it becomes obvious that different embodiments described in view of one aspect can likewise be implemented in view of other aspects of the disclosure.

### Transparency Information Metadata:

As mentioned above, it is essential that the content creator can signal the expected transparency (and opacity) region of pixels of the transmitted video, such that a proper user experience can be provided to the viewer. To this end, the disclosure might provide different types of metadata that can be used, either exclusively or in combination:
binary mask
integer-based mask
shape-based mask

### Transparency Binary Mask:

A binary mask (see also citation Error! Reference source not found.) is a general concept in image processing, whereby each pixel of an image is associated with a one-bit information (also called flag). This mask is thus typically a 2D matrix of the same dimension (width and height) as that of the associated image, and contains one bit as its elements. In this case, there is a one-to-one mapping between a pixel of the image and an element of the binary mask. However, there can be cases where the binary mask is of a different dimension than the image (usually smaller), so that the amount of information stored in the binary mask is lower. When this is the case, one needs to upsample the binary mask, i.e. artificially increase the dimension of the binary mask up to the one of the image, so that the relationship between a pixel of the image and an element of the mask can be established. Upsampling is in general well-known from other image fields and various techniques can be used for this purpose. In particular, one may use a technique for sampling that takes into account the nature of the input data which is here a binary mask. General upsampling filter used for upsampling pictures may not give the ideal result. For example, a rectangle region in the input binary mask with straight edges may become a rectangle with round edges after upsampling. Ideally, the upsampling should preserve certain characteristics of the binary masks used for the purposed of signalling transparency region. For instance, preserving shapes seems an interesting feature of the upsampling operation in this case.

In the context of this disclosure, the values of transparency binary mask would express for instance:
the pixel is transparent when the value is 0.
the pixel is opaque when the value is 1.

This is merely one convention and the opposite convention on the meaning of zeros and ones can be swapped.

### Signalling:

For the purpose of the disclosure, the transparency information needs to travel with the video signal up to the receiver which means from the encoding step (e.g. in a studio, on a server) up to the receiver (e.g. the TV receiver, a smartphone, a tablet, a HMD glasses, etc). As a result, one may transmit the transparency information as part of video bitstream metadata.

For illustrating the transport of the information, the following is an example based on the NAL-based video codec standards which are currently H.264/AVC, H.265/HEVC, EVC and H.266/VVC. But similar signalling could be achieved for other coding standards such as AV1 or the upcoming AV2 standard developed by the Alliance for Open Media.

A Network Abstraction Layer (NAL) unit is the encapsulation method for a video bitstream. A NAL is composed of a header and a payload. The concept of NALs is identical for those three standards although the definition of the NAL header may vary slightly between H.264/AVC, H.265/HiEVC, EVC and H.266/VVC.

For the remaining of this section, the signalling will take the VVC standard as a basis for illustration purposes.

Table 1 is the general syntax of a NAL unit as defined in H.266/VVC. The formatting of those tables follows the conventions defined in H.266/VVC. Please refer to section 7.1 Method of specifying syntax in tabular form and 7.2 Specification of syntax functions and descriptors in H.266/VVC (see citation Error! Reference source not found.).

TABLE 1
General NAL unit syntax as defined in H.266/VVC

| | Descriptor |
|---|---|
| nal_unit( NumBytesInNalUnit ) { | |
| nal_unit_header( ) | |
| NumBytesInRbsp = 0 | |
| for( i = 2; i < NumBytesInNalUnit; i++ ) | |
| if( i + 2 < NumBytesInNalUnit && next_bits( 24 ) = = | |
| 0x000003 ) { | |
| rbsp_byte[ NumBytesInRbsp++ ] | b(8) |
| rbsp_byte[ NumBytesInRbsp++ ] | b(8) |
| i += 2 | |
| emulation_prevention_three_byte /* equal to | f(8) |
| 0x03 */ | |
| } else | |
| rbsp_byte[ NumBytesInRbsp++ ] | b(8) |
| } | |

The signalling may comprise a new type of Supplemental Enhancement Information (SEI) message. SEI are metadata carried in a video bitstream of AVC, HEVC or VVC that may not be needed for the decoding of the video but may be useful for some processing after decoding. Each SEI type defines the syntax of the payload as well as the semantic of the data so that the implementer can make use of the signalled SEI if they want to support it. An SEI message is carried in the video bitstream as a NAL unit and the type of SEI is expressed by a payload type. In H.266/VVC, the payload types are defined in section D.2.1 General SEI payload syntax. For signalling the transparency mask, one may thus define a new payload type, e.g. payload type ‘134’ as part of the current reserved range of values as in Table 2.

TABLE 2
Modification of general SEI payload syntax in H.266/VVC

Descriptor

```
sei_payload( payloadType, payloadSize ) {
  if( nal_unit_type = = PREFIX_SEI_NUT )
    if( payloadType = = 0 )
      buffering_period( payloadSize )
    else if( payloadType = = 1 )
      pic_timing( payloadSize )
      ...
    else if( payloadType = = 133 )
      scalable_nesting( payloadSize )
    else if( payloadType = = 134 )
      transparency_mask ( payloadSize )
    else /* Specified in Rec. ITU-T H.274 | ISO/IEC 23002-
7 */
      reserved_message( payloadSize )
  ...
}
```

Simple Signalling without Size-Efficient Syntax for the Mask Values:

The new payload type may be defined as in Table 3.

TABLE 3
Signalling of binary transparency mask as SEI

| | Descriptor |
|---|---|
| transparency_mask( payloadSize ) { | |
| mask_size_present_flag | u(1) |
| if(mask_size_present_flag) { | |
| mask_width | ue(v) |
| mask_height | ue(v) |
| } | |
| for(i=0; i < MaskHeight; i++) | |
| for(j=0; j < MaskWidth; j++) | |
| mask_value[ i ][ j ] | u(1) |
| } | |

mask size_present_flag equal to 1 specifies that the payload contains explicit width and height of the mask. When equal to 0, the width and the height of the mask is inferred.

mask width specifies the width of the transparency mask.

mask height specifies the height of the transparency mask.

The variables MaskHeight and MaskWidth are determined as follows:

```
if(mask_size_present_flag) {
  MaskWidth = mask_width
  MaskHeight = mask_height
} else {
  MaskWidth = pps_pic_width_in_luma_samples
  MaskHeight = pps_pic_height_in_luma_samples
}
```

mask value[i][j] specifies the transparency of the collocated luma sample. When mask value[i][j] is equal to 1, the collocated luma sample is transparent. When mask value[i][j] is equal to 1, the collocated luma sample is opaque. When MaskWidth or MaskHeight are not equal to respectively pps_pic_width_in_luma_samples or pps_pic_height_in_luma_samples, the collocated luma sample is determined after resampling of the transparency mask. The transparency attribute of a luma sample is transferred to its associated samples (e.g. chroma samples) for display.

Simple Signalling with Size-Efficient Syntax for the Mask Values:

The amount of data may be significant, especially for high resolution videos. It is possible to reduce the dimension (width and height) of the mask but this may cause a loss of quality in the accuracy of mask after upsampling back to the video resolution. Alternatively to reducing the mask size or even complementary to it, one may define a syntax wherein the values of the mask are coded in a bit-efficient way. Several compression algorithms may be used but for the coding of the mask where large regions are expected to be signaled, the run-length encoding Error! Reference source not found. scheme appears to be particularly appropriate.

TABLE 4
Signalling of binary transparency mask
as SEI with optional RLE compression

| | Descriptor |
|---|---|
| transparency_mask( payloadSize ) { | |
| mask_size_present_flag | u(1) |
| if(mask_size_present_flag) { | |
| mask_width | ue(v) |
| mask_height | ue(v) |
| } | |
| rle_scheme_used_flag | u(1) |
| if(rle_scheme_used_flag) { | |
| number_of_runs | ue(v) |
| for(i=0; i < number_of_runs; i++) { | |
| run_value[ i ] | u(1) |
| run_length[ i ] | ue(v) |
| } | |
| } else { | |
| for(i=0; i < MaskHeight; i++) | |
| for(j=0; j < MaskWidth; j++) | |
| mask_value[ i ][ j ] | u(1) |
| } | |
| } | |

mask size_present_flag equal to 1 specifies that the payload contains explicit width and height of the mask. When equal to 0, the width and the height of the mask is inferred.

mask width specifies the width of the transparency mask.

mask height specifies the height of the transparency mask.

The variables MaskHeight and MaskWidth are determined as follows:

```
if(mask_size_present_flag) {
  MaskWidth = mask_width
  MaskHeight = mask_height
} else {
  MaskWidth = pps_pic_width_in_luma_samples
  MaskHeight = pps_pic_height_in_luma_samples
}
```

rle_scheme_used_flag equal to 1 specifies that the mask values are run-length encoded. When equal to 0, the mask values are signaled explicitly.

number_of_runs specifies the number of runs.

run_value[i] specifies the value of the i-th run.

run_length[i] specifies the length of the i-th run.

mask value[i][j] specifies the transparency of the collocated luma sample denoted by the variable LumaTransparency[i][j]. When mask_value[i][j] is equal to 1, the collocated luma sample is transparent. When mask_value[i][j] is equal to 1, the collocated luma sample is opaque. When MaskWidth or MaskHeight are not equal to respectively pps_pic_width_in_luma_samples or pps_pic_height_in_luma_samples, the collocated luma sample is determined after resampling of the transparency mask. The transparency attribute of a luma sample is transferred to its associated samples (e.g. chroma samples) and then to the collocated converted samples (e.g. RGB samples) for display. When mask value[i][j] is not present (i.e. RLE scheme used), the value of LumaTransparency[i][j] is inferred as follows:

```
if(rle_scheme_used_flag) {
  int i = 0
  int j = 0
  for(k=0; k < number_of_runs; k++) {
    for(l=0; l < run_length[ k ]; l++) {
      LumaTransparency [ i ][ j ] = run_value[ k ]
      if(i < MaskWidth) {
        i++
      } else {
        i = 0
        j++
      }
    }
  }
} else {
  for(i=0; i < MaskHeight; i++)
    for(j=0; j < MaskWidth; j++)
      LumaTransparency [ i ][ j ] = mask_value[ i ][ j ]
}
```

As a side note, when the RLE scheme is used, the following applies:

$$MaskWidth \times MaskHeight = {\sum }_{k = 0}^{number\_of \_runs - 1} run\_length [ k ]$$

### Transparency Integer-Based Mask:

According to some embodiments, the transparency attribute is no longer a binary attribute but it is coded on a scale of values. Depending on the accuracy of the transparency effect on the display, one may choose to encode the mask on a range of 8, 10, 12 or even 16 bit values, respectively allowing 256, 1024, 4096, or 65536 different values.

In the context of the present disclosure, the values of transparency integer-based mask may, for instance, express the following:
the pixel is fully transparent when the value is 0.
the pixel is fully opaque when the value is max_value.
for any value between 0 and max_value, the pixel is partially transparent following a certain function (e.g. linear function).
max_value is the maximum value allowed by the chosen bit depth, e.g. 255 for an 8-bit scale.

### Signalling:

The signalling would be similar to the signalling described above in view of transparency binary mask, with the difference that mask_value [i][j] and run value[i] are no longer u(1) (i.e. one Boolean value) but coded as an integer field. One may choose to encode them using the descriptor u(bit_depth) with the chosen bit_depth, e.g. u(8) for a field code on 8 bits. Alternatively, other integer coding schemes may be used such as ue(v) if deemed offering a better coding efficiency of those fields. However, if the type ue(v) is chosen, this means that the maximum value of the range needs to be signalled. Indeed, the maximum value is implicitly signalled when one chooses a bit depth of 8, 10 etc., but when choosing ue(v) as coded method, there is no explicit highest value anymore.

### Transparency Shape-Based Mask:

According to some embodiments, the transparency attributes are no longer expressed as a mask (i.e. a matrix of elements) but as one or several geometric shapes. Those geometric shapes are defined by the coordinates and the size of a specific shape as well as a value or a parametric function providing the transparency attributes.

### Signalling:

According to these embodiments, the metadata does not describe a 2D matrix of elements but instead a collection of shapes that in turn, can be used to derive a 2D matrix of elements.

TABLE 5
Signalling of shape-based transparency mask as SEI

| | Descriptor |
|---|---|
| transparency_mask( payloadSize ) { | |
| mask_size_present_flag | u(1) |
| if(mask_size_present_flag) { | |
| mask_width | ue(v) |
| mask_height | ue(v) |
| } | |
| number_of_shapes | ue(v) |
| for(i=0; i < number_of_shapes; i++) { | |
| shape_type[ i ] | u(3) |
| shape_mask_value[ i ] | u(1) |
| shape_center_x[ i ] | ue(v) |
| shape_center_y[ i ] | ue(v) |
| shape_width[ i ] | ue(v) |
| shape_height[ i ] | ue(v) |
| } | |
| } | |

mask size_present_flag equal to 1 specifies that the payload contains explicit width and height of the mask. When equal to 0, the width and the height of the mask is inferred.

mask width specifies the width of the transparency mask.

mask height specifies the height of the transparency mask.

The variables MaskHeight and MaskWidth are determined as follows:

```
if(mask_size_present_flag) {
  MaskWidth = mask_width
  MaskHeight = mask_height
} else {
  MaskWidth = pps_pic_width_in_luma_samples
  MaskHeight = pps_pic_height_in_luma_samples
}
```

number_of_shapes indicate the number of shapes composing the mask.

shape_type[i] specifies the type of the i-th shape. When equal to 0, the signaled shape may be rectangle. When equal to 1, the shape may be an ellipse.

shape_mask_value[i] specifies the transparency of the i-th shape. When shape_mask_value[i] is equal to 1, the luma samples covered by the shape are transparent. When shape_mask_value[i] is equal to 0, the luma samples covered by the shape are opaque.

shape_center_x[i], shape_center_y[i], shape_width[i], shape_height[i] specify respectively the horizontal coordinate, the vertical coordinate, the width and height of the i-th shape. The interpretation of width and height depends on the shape type. The luma samples whose position are covered by the i-th shape inherit from the transparency value of this i-th shape indicated by shape_mask_value[i].

It should be noted that, in the described example, a bit depth of 8 has been chosen for the value range of the mask which is coded in the field shape_mask_value. This is an arbitrary choice as said in previous embodiments and implementations may use other ranges of values appropriate for the available display at the time of the implementation.

More complex signaling might be envisioned like a configurable rotation of the shapes. However, the described signaling seems to be a good tradeoff between expressivity and complexity. In particular, the example signaling for shape-based mask seems appropriate for videos containing blocks such as user interfaces, i.e. windows, buttons, bars, etc., where—for instance—rotation of the shapes is not obviously needed.

### Transparency-Driven Picture Adjustment:

As discussed above, there exist different transparent display technologies. However, it is possible to generalize the post decoding in the following manner.

It may be assumed that:
the transparent display can achieve different degrees of transparency.
the transparency of a pixel in the display is controlled by a linear function.

Furthermore, it may be assumed that:
TransparentColor denotes the colour providing the highest transparency for the display and
TransparencyPercentage denotes the desired percentage of transparency on the display comprised between 0 and 1.

The decoder outputs the raw decoded video. Typically, the decoded video is of a YCbCr format (see citation [16]). If the output of the decoder is meant to be displayed as is, the transparent adjustment process can be performed directly on the YCbCr signal. Alternatively, the process can also be performed in the RGB domain, since screens generally operate based on a RGB format for display. That is why, in most cases, a conversion from a YCbCR format to a RGB format is performed. This means that the signalled transparency mask is transferred to the converted RGB signal.

Based on the converted RGB signal and the mask, the receiver is thus expected to adjust the converted RGB signal to a transparency-adjusted RGB signal.

### For Binary Transparency Information:

For each pixel of the RGB signal where a pixel is composed of three components (R, G and B), the following operation may be performed:

$$AdjustedRGBPixel = ( 1 - TransparencyFlag ) \times ConvertedRGBPixel + TransparencyFlag \times TransparentColor$$

For instance, TransparentColor may be black such as for the OLED-based transparent screens. Black is given by the RGB triplet (0,0,0). It shall be assumed that a given RGB pixel is white, i.e. (255,255,255) for an 8 bit-display and the transparent flag signaled in the binary mask is 1, thus expressing that the pixel is fully transparent. In this case, the following applies:

$$AdjustedRGBPixel = ( 1 - 1 ) \times \begin{matrix}255 \\ 255 + 1 \times \\ 255\end{matrix} \begin{matrix}0 \\ 0 \\ 0\end{matrix}$$

$$AdjustedRGBPixel = \begin{matrix}0 \\ 0 \\ 0\end{matrix}$$

By this process, a pixel that was fully opaque (white) becomes fully transparent (black).

If the process is performed in a YCbCr format, a similar adjustment is performed but the TransparentColor value would be different. For a black pixel, it would be (0, 128, 128).

### For Integer-Based Transparency Information:

For each pixel of the RGB signal where a pixel is composed of three components (R, G and B), the following operation may be performed:

$$AdjustedRGBPixel = ( 1 - TransparencyPercentage ) \times ConvertedRGBPixel + TransparencyPercentage \times TransparentColor$$

For instance, TransparentColor may be black such as for the OLED-based transparent screens. Black is given by the RGB triplet (0, 0, 0). It shall be assumed that a given RGB pixel is white, i.e. (255, 255, 255) for an 8 bit-display and the transparent percentage signaled in the mask is 0.8. In this case, the following applies:

$$AdjustedRGBPixel = ( 1 - 0.8 ) \times \begin{matrix}255 \\ 255 + 0.8 \times \\ 255\end{matrix} \begin{matrix}0 \\ 0 \\ 0\end{matrix}$$

$$AdjustedRGBPixel = \begin{matrix}51 \\ 51 \\ 51\end{matrix}$$

By this process, a pixel that was fully opaque (white) becomes much darker with a transparency factor of 0.8, hence becoming largely transparent.

If the process is performed in a YCbCr format, the similar adjustment is performed but the TransparentColor value would be different. For a black pixel, it would be (0, 128, 128).

### Dimming Information Metadata:

Similar to transparency information, there exist devices with a dimming plane that blocks the light coming from behind the display, irrespective from the state of the displayed pixels (i.e. transparent or opaque). Such information can be similarly transmitted as part of the video bitstream so that each picture of a video sequence may be displayed as intended. The dimming information relates to a display device comprises a dimming layer as the one disclosed in citation [11].

According to some embodiments, the steps performed during decoding and encoding might be described as follows.

### Decoding Method:

1. Receive an encoded video bitstream comprising transparency information
2. For each encoded video picture:
   a. Decode the encoded video picture in a decoded picture
   b. If new transparency information present, parse the transparency information
   c. Determine the transparency information associated with the decoded picture
   d. Adjust the value of the sample in the decoded video sequence on the basis of the parsed transparency information.
3. Optionally, display the transparency-adjusted decoded video sequence

While the steps above are enumerated in one possible way of implementation, the order of the above steps is not mandatory. In particular, it is also possible to perform the above-recited steps b and c before or parallel to step a.

### Encoding Method:

1. Receive an input video sequence
2. For each input video picture:
   a. Encode the video picture
   b. Determine an associated transparency mask
   c. Write the encoded video frame into the output bitstream, optionally with an updated information signalling the transparency mask

In FIG. 1, the basic principle of an LCD as known from the prior art is illustrated. As shown in FIG. 1, a liquid crystal 13 constitutes the core of the LCD setup. The liquid crystal 13, which can be a twisted nematic liquid crystal, is arranged between a first transparent electrode 12 and a second transparent electrode 14 which are implemented as glass substrates comprising an electric layer. Typically, the electrodes 12, 14 comprise an ITO (Indium-Tin-Oxide) layer. The liquid crystal 13 and the electrodes 12, 14 are arranged between two polarizing filters 11, 15. The first polarizing filter 11 has a vertical axis and is configured to polarize entering light. In contrast, the second polarizing filter 15 has a horizontal axis and is configured to block or pass the incident light depending on the voltage applied at the electrodes 12, 14. Finally, the LCD illustrated in FIG. 1 comprises a reflective surface 16 to send light back to the viewer. In a backlit LCD, this layer is replaced or complemented with a light source.

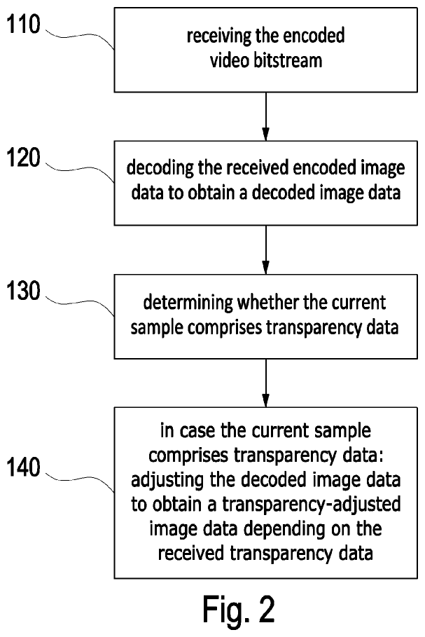

In FIG. 2, one embodiment of the decoding method according to the disclosure is shown. In a first step 110, an encoded video bitstream is received by a decoding device. The video bitstream comprises image data and transparency data. The following steps 120, 130, 140 are conducted consecutively for each frame of the video bitstream. In step 120, the encoded image data contained in the video bitstream is decoded in order to obtain a decoded image data. In step 130, it is determined whether the current frame is associated with transparency data. Finally, in step 140, the decoded image data is adjusted, in case the current frame is associated with transparency data. The adjustment is conducted depending on the received transparency data and according to the requirements of a specific display device and possibly on ambient light data, if available. Hence, the adjustment of the image data is different for an LCD and an OLED device and possibly different for the same display technology but under different ambient light conditions.

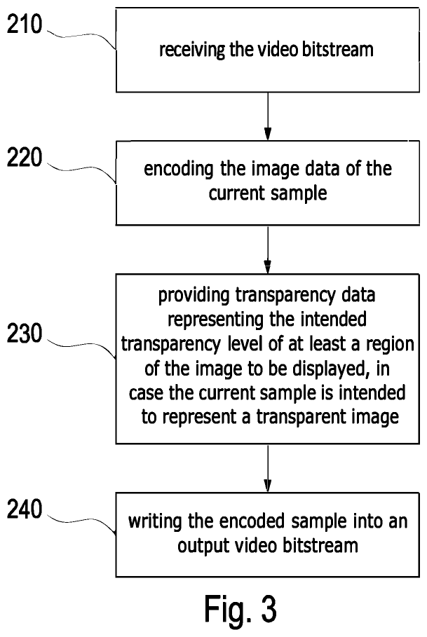

In FIG. 3, one embodiment of the encoding method according to the disclosure is shown. In a first step 210, a video sequence is received. The video sequence comprises image data with multiple image values representing an image to be displayed. The steps following the first step 210, namely method steps 220, 230, 240 are conducted consecutively for each frame of the video sequence. In step 220, the image data of the current frame is encoded. In step 230, transparency data is provided, representing the desired transparency level of at least a region of the image to be displayed, if the current frame is intended to represent a transparent image. Finally, in step 240, the encoded frame is written into an output bitstream. In some embodiments, the output bitstream comprises transparency data representing the transparency properties of a number of the images contained in the video bitstream.

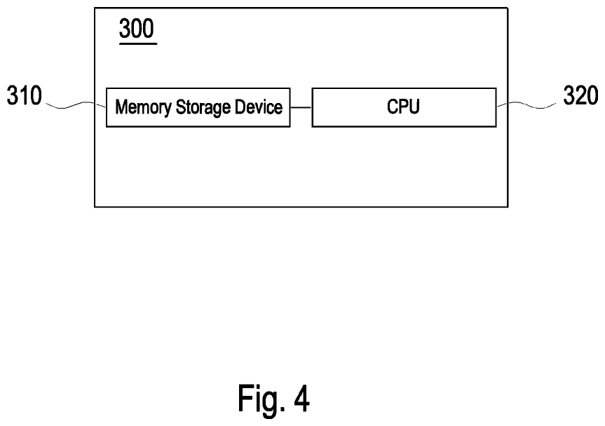

In FIG. 4, one embodiment of the decoding device 300 according to the disclosure is illustrated. The decoding device 300 comprises a storage element 310 (also referred to as a memory element or, in short, a memory) for storing an encoded video bitstream or at least a part of the video bitstream. The decoding device 300 further comprises a processor unit 320 (also referred to as a processor) being configured to conduct the steps of the decoding method as described with reference to FIG. 2.

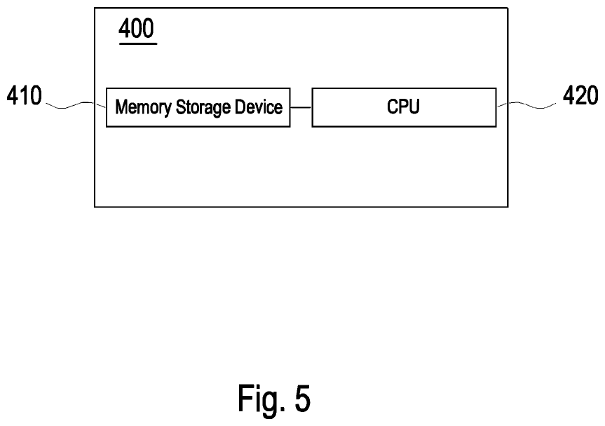

In FIG. 5, one embodiment of the encoding device 400 according to the disclosure is shown. The encoding device comprises a storage element 410 (also referred to as a memory element or, in short, a memory) for storing a received video sequence or at least a part of the video sequence. The encoding device 400 further comprises a processor unit 420 (also referred to as a processor) being configured to conduct the steps of the encoding method as described with reference to FIG. 3.

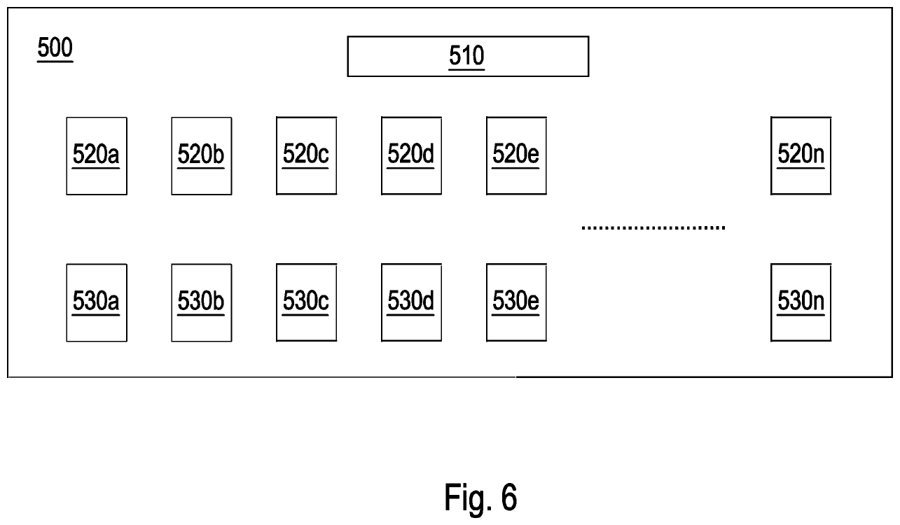

Further, FIG. 6 shows an embodiment of a video bitstream 500 according to the disclosure. The video bitstream 500 comprises encoded image data 520 and transparency data 530. The encoded image data 520 comprises image information for all the samples of this image of a video bitstream. In addition, the video bitstream 500 comprises header parameters 510. The header parameters 510 may comprise additional information that can be useful for the decoding or for post-decoding process of the encoded image data. According to illustrated embodiment, the video bitstream 500 also comprises transparency data 530 for one or more of the encoded image data of the video bitstream 500. For instance, the header parameters 510 might indicate that an SEI is provided. Hence, the video bitstream 500 might further comprise Supplemental Enhancement Information (SEI). The SEI may comprises one or several indicators. For instance, the SEI might comprise an indicator that indicates whether or not the video bitstream 500 comprises transparency data 530. Also, the SEI may comprise an indicator that indicates if the transparency data 530 is encoded and—in case the transparency data 530 is encoded—which encoding technique is used for encoding the transparency data 530.

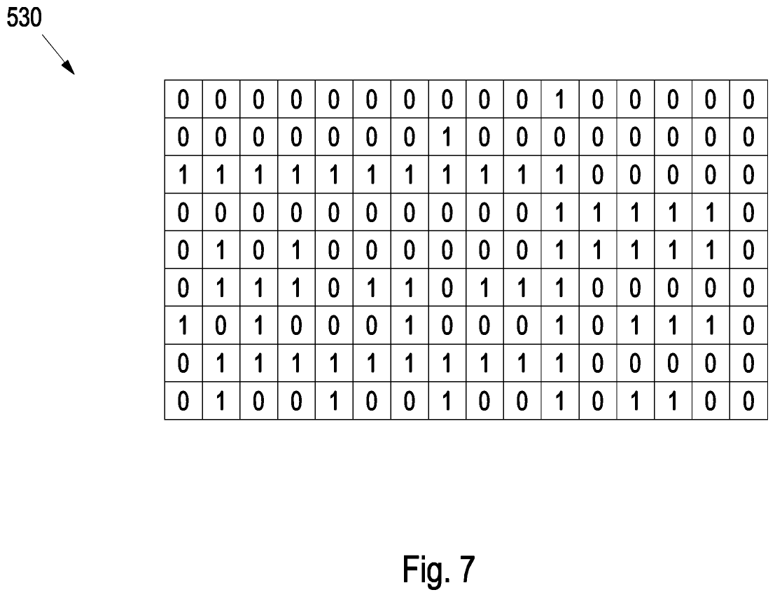

Finally, FIG. 7 shows an embodiment of the transparency data 530 according to the disclosure. The illustrated embodiment relates to the case where the transparency data 530 encodes a binary mask. In FIG. 7, the binary mask comprises 16×9 binary transparency values. The binary values (i.e. the zeros and ones contained in the transparency data 530) encode whether a specific pixel of an image is intended to be displayed in a transparent or an opaque mode. For instance, if a transparency value equals to one, this information might encode that the specific pixel is intended to be displayed in a transparent mode, while a transparency value that equals to zero may encode that the corresponding pixel of the image is intended to be displayed in an opaque mode. However, an opposite convention might be implemented as well defining that a transparency values equal to 1 represents an opaque pixel of the image, wherein a transparency value equal to 0 represents a transparent pixel of the image.

In some embodiments, the binary mask might have the same dimensions as the image data. For instance, the binary mask might comprise 1920×1080 binary values. Also, the binary mask might have reduced dimensions when compared with the dimensions of the image data. For instance, the dimensions of the binary mask might be reduced by a factor of 2 and 4 when compared to the corresponding image data. In this way, the entire information contained in the transparency data 530 might be reduced by a factor of 4 or 16, thus, resulting in a compact representation of the transparency data 530.

According to the example illustrated in FIG. 7, the transparency data 530 comprises 10 zeros in the first row. In spite of explicitly reproducing all values of the transparency data 530, it is possible to use a run-length encoding approach to efficiently compress the transparency data 530. For instance, instead of reproducing the first 10 zeros in the first row, the transparency data 530 might encode that the value of zero will be reproduced 10 times, thus significantly reducing the amount of information that needs to be stored on a storage medium or transmitted to a decoding device. Accordingly, the repeatedly reproduced ones contained in the transparency data 530 might be encoded using the same encoding principle as discussed above.

### Abbreviations Used in the Context of the Present Disclosure

In the present disclosure, the following abbreviations have been used:
AVC ISO/IEC 14496-10 Advanced Video Coding (AVC)/ITU-T Recommendation H.264 Error! Reference source not found.
EVC ISO/IEC 23094-1 Essential video coding (EVC)
HEVC ISO/IEC 23008-2 High Efficiency Video Coding (HEVC)/ITU-T Recommendation H.265 Error! Reference source not found.
VVC ISO/IEC 23090-3 Versatile Video Coding (VVC)/ITU-T Recommendation H.266 Error! Reference source not found.
AV1 AOMedia Video 1 (AV1)

### Definitions

The following definitions have been used in the context of this disclosure:

### 1. Pixel

A pixel corresponds to the smallest display unit on a screen which can be composed of one or more sources of light (1 for monochrome screen or 3 or more for colour screens)

### 2. Sample

A sample is the smallest visual information unit of a component composing a picture or a frame of a decoded video sequence. A picture or a frame can be composed of one or more components, one component for monochrome picture or frames, and traditionally three components for colour picture or frames.

1. A method for displaying a video on a transparent display, the method comprising:
receiving an encoded video bitstream, wherein the encoded video bitstream comprises image data comprising multiple image values representing an image to be displayed and transparency data representing an intended transparency level of at least a part of the image to be displayed; and
for at least one frame of the video bitstream:
decoding the received encoded image data to obtain a decoded image data;
determining whether a current frame is associated with transparency data; and
in case that the current frame is associated with the transparency data, adjusting the decoded image data to obtain a transparency-adjusted image data depending on the received transparency data.

2. The method according to claim 1, wherein the transparency data comprises binary values representing the intended transparency level of the at least a part of the image to be displayed; or
wherein the transparency data comprises integer values representing the intended transparency level of the at least a part of the image encoded in the image data, wherein the integer values comprise N bit of data, N corresponding to 8, 10, 12 or 16.

3. (canceled)

4. The method according to claim 1, wherein the transparency data comprises region parameters representing a defined region within the image represented by the image data, wherein one or several transparency values are allocated to the defined region.

5. The method according to claim 1, wherein the transparency data comprises a reduced number of transparency values in comparison to a number of image values comprised in the image data and wherein the method comprises the additional step of upsampling the transparency data to match dimensions of the image data.

6. The method according to claim 1, wherein the video bitstream comprises Supplemental Enhancement Information (SEI).

7. The method according to claim 6, wherein the SEI comprises a payload type indicator indicating whether the transparency data is contained in the video bitstream, and the method further comprises:
determining whether the payload type indicator equals to a first predetermined value representing a presence of the transparency data; and
adjusting the decoded image data depending on the transparency data, in case that the payload type indicator equals to the first predetermined value.

8. The method according to claim 6, wherein the SEI comprises a run-length encoding indicator indicating whether the transparency data is run-length encoded, and the method further comprises the further steps of:
determining whether the run-length encoded indicator equals to a second predetermined value representing that the transparency data is run-length encoded; and
decoding the run-length encoded transparency data using a run-length decoding method, in case that the run-length encoding indicator equals to the second predetermined value.

9. A method for displaying a video on a transparent display comprising:
decoding an encoded video bitstream with multiple frames according to the method of claim 1; and
displaying an image according to the transparency-adjusted decoded image data in case that the current frame is associated with transparency data and, displaying an image corresponding to the decoded image data in case that the current frame is associated with the transparency data.

10. A method for displaying a video on a transparent display, the method comprising the following steps:
receiving a video sequence, wherein the video sequence comprises image data comprising multiple image values representing an image to be displayed;
for at least one frame of the video sequence:
encoding the image data of a current frame;
providing transparency data representing an intended transparency level of at least a region of the image to be displayed, in case that the current frame is intended to represent a transparent image; and
writing the encoded frame into an output video bitstream.

11. The method according to claim 10, wherein the transparency data comprises binary values representing the intended transparency level of at least a part of the image to be displayed; or
wherein the transparency data comprises integer values representing the intended transparency level of the at least a part of the image encoded in the image data, wherein the integer values comprise N bit of data, N corresponding to 8, 10, 12 or 16.

12. (canceled)

13. The method according to claim 10, wherein the transparency data comprises region parameters representing a defined region within the image represented by the image data, wherein one or several transparency values are allocated to the defined region.

14. The method according to claim 10, wherein the transparency data comprises a reduced number of transparency values in comparison to a number of image values comprised in the image data.

15. The method according to claim 14, wherein the transparency data is determined by downsampling transparency data comprising same dimensions as the image data.

16. The method according to claim 10, wherein the method further comprises providing Supplemental Enhancement Information (SEI) to the output video bitstream.

17. The method according to claim 16, wherein the SEI is provided with a payload type indicator indicating whether transparency data is contained in the video bitstream, wherein the payload type indicator is set to a first predetermined value indicating that the transparency data is contained in the video bitstream.

18. The method according to claim 10, further comprising run-length encoding the transparency data, wherein Supplemental Enhancement Information (SEI) is provided to the output video bitstream comprising a run-length encoding indicator, wherein the run-length encoding indicator indicates whether the transparency data is run-length encoded, wherein the run-length encoding indicator is set to a second predetermined value indicating that the transparency data is run-length encoded.

19. A decoding device comprising a processor for decoding an encoded video bitstream comprising multiple frames, wherein the decoding device is configured to:
receive the encoded video bitstream, wherein the video bitstream comprises image data comprising multiple image values representing an image to be displayed and transparency data representing an intended transparency level of at least a part of the image to be displayed; and
wherein the processor is, for at least one frame of the video bitstream, configured to:
decode received image data to obtain a decoded image data;
determine whether a current frame is associated with transparency data;
in case that the current frame is associated with transparency data, adjust the decoded image data to obtain a transparency-adjusted image data depending on the received transparency data.

20-22. (canceled)

23. A display device for displaying a transparent image, comprising a decoding device according to claim 19; and a transparent screen, wherein the decoding device is configured to output the transparency-adjusted image data to the transparent screen.

24. (canceled)

25. An encoding device comprising a processor for encoding a received video sequence, wherein the encoding device is configured to perform the method of claim 10.

26-28. (canceled)

29. A video bitstream with multiple frames for displaying a video on a transparent display, wherein the bitstream comprises image data comprising multiple image values representing an image to be displayed and transparency data representing an intended transparency level of at least a part of the image to be displayed, wherein the video bitstream is generated by the method according to claim 10.

30. (canceled)
